(19) United States
(12) Patent Application Publication
(10) Pub. No.: US 2017/0053219 A1
(43) Pub. Date: Feb. 23, 2017

(54) FIELD-DEPLOYED SALES AND CONFIGURATION SYSTEM

(71) Applicant: sympl inc., San Rafael, CA (US)

(72) Inventors: Jason Wright, San Anselmo, CA (US); Scott Marchand, Tiburon, CA (US); Dustin A. Mendes, San Francisco, CA (US)

(21) Appl. No.: 15/239,270

(22) Filed: Aug. 17, 2016

Related U.S. Application Data
(60) Provisional application No. 62/205,904, filed on Aug. 17, 2015.

(51) Int. Cl. G06Q 10/06; G06F 3/0481; G06F 3/0488; G06F 3/0484

(52) U.S. Cl. CPC G06Q 10/0633; G06F 3/04842; G06F 3/04817; G06F 3/0488

(57) ABSTRACT

Provided is a process, including: receiving, via the Internet, a request to view an project from a first computing device; sending instructions to display a floor plan of a building to the first computing device; receiving, via the Internet, a request to view the project from a second computing device; sending instructions to display project statistics to the second computing device; receiving, from the first computing device, a request to modify a component to be installed in the building; and in response to the request to modify: updating project statistics; and sending instructions to display updated statistics to the second computing device.

### CROSS-REFERENCE TO RELATED APPLICATIONS

The present application claims the benefit of U.S. Provisional Patent Application 62/205,904, filed 17 Aug. 2015. The entire content of each parent application is incorporated by reference in its entirety.

### BACKGROUND

1. Field

The present invention relates generally to electronic systems and, more specifically, to sales and configuration systems.

2. Description of the Related Art

Software tools can serve one or more of a variety of purposes in efforts to augment buildings and property. Often such tools are used in the project definition phase, for example to define the scope of work, select components for the project, and budget costs. Such tools may also be used for workflow management, for example tracking the status of the project and various tasks to be performed by various parties participating in the project.

Existing tools are not well-suited for certain types of projects. In some projects, such as high-and, residential audiovisual installations, the projects include a relatively diverse array of stakeholders, ranging from the consumer who may be unfamiliar with the software and have very limited time and knowledge, and to specialists who use the software daily and advise the consumers. Existing tools often are used in the background, separate from meetings with consumers, because those tools are not well-suited for both consumer and specialists use. As a result, iterative project definition processes can drag on, in some cases for weeks, as project specialists and consumers meet, the specialist returns to their software to redesign the project, and then the parties coordinate another meeting with each iteration. Further, such systems often deprive consumers of a deep understanding of the consequences of their choices for the budget and configuration constraints.

### SUMMARY

The following is a non-exhaustive listing of some aspects of the present techniques. These and other aspects are described in the following disclosure.

Some aspects include a process, including: receiving, via the Internet, a request to view an project from a first computing device; sending instructions to display a floor plan of a building to the first computing device; receiving, via the Internet, a request to view the project from a second computing device; sending instructions to display project statistics to the second computing device; receiving, from the first computing device, a request to modify a component to be installed in the building; and in response to the request to modify: updating project statistics; and sending instructions to display updated statistics to the second computing device.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a sales and configuration system in accordance with some of the present techniques;

FIG. 2 shows an example of a sales and configuration process in accordance with some of the present techniques;

FIG. 3 shows an example of a first graphical user interface on a first field-deployed computing device of a sales and configuration process in accordance with some of the present techniques;

FIG. 4 shows an example of a second graphical user interface on a second field-deployed computing device of a sales and configuration process in accordance with some of the present techniques and used concurrently with first field-deployed computing device; and

FIG. 5 shows an example of a computer system by which the present techniques may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of sales and configuration. Indeed, the inventors wish to emphasize the difficulty of recognizing those problems that are nascent and will become much more apparent in the future should trends in the enterprise software industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Some embodiments have unique features (which is not to imply that this is a comprehensive list of such features, or that all embodiments have all of these features) that make those embodiments an ideal (or better than many traditional systems) tool for salesperson/customer real-time (e.g., within the range of acceptable network latency and processing time, such as systems that respond within five to ten seconds) collaborations, including:
1) floorplan-based design (versus merely providing bill of materials lists), which is graphical and illustrative and more intuitive for consumers than traditional systems;
2) real-time budget feedback, and also including graphical illustration (for instance, a bell curve) of typical budgets versus the customer's current budget;
3) the ability to cluster several products together into a “group” that can be added as a single item (e.g., TV icon represents a group of products that include the TV itself, bracket, universal remote, cable box, wiring, labor, tax, etc.).

Again, it should be stressed that the above features only pertain to some of the embodiments consistent with the present techniques, as several problems are solved, and those solutions are independently useful.

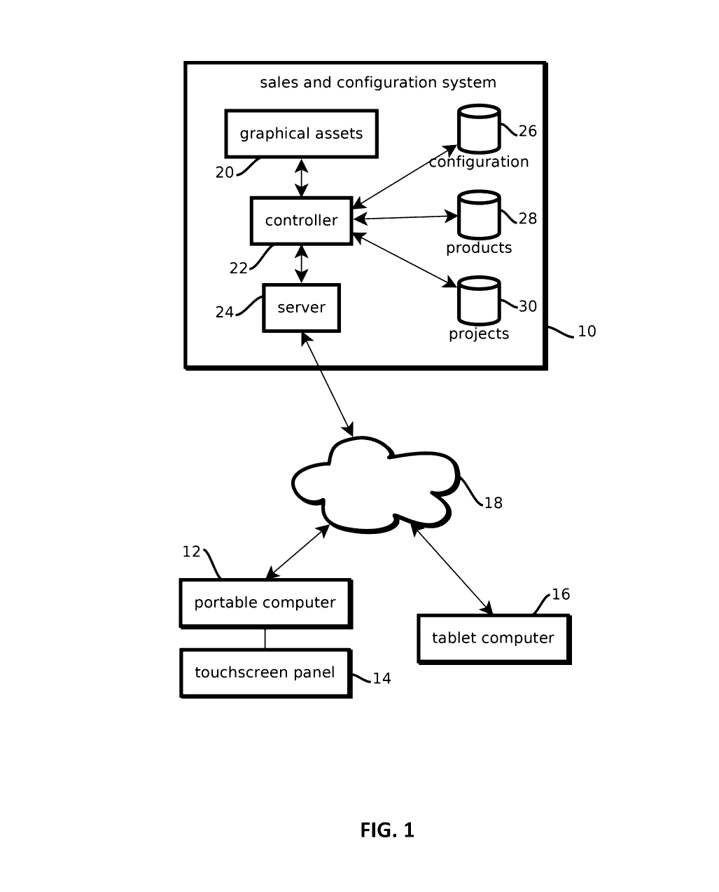

Some of the above-noted problems may be mitigated by some embodiments of the sales and configuration system illustrated by FIG. 1. In some embodiments, one or more portable computing devices may be brought with a project specialist to a meeting with the consumer, for example, at a job site or in the consumer's home, and the project specialist and the consumer may collaboratively define the project scope (e.g., at least part of the project scope) in real time (e.g., over the course of the meeting) by remotely interfacing with the sales and configuration system.

The present techniques may be configured for and deployed in a wide-variety of use cases. Some embodiments may be used in a professional design consultation, e.g., in a meeting between a designer and a consumer-client. Some embodiments may be used in a platform deployed by equipment manufacturers to assist their sales force and authorized retailers to facilitate sales and configuration, e.g., as part of an integrated e-commerce platform in which products and designs may be configured and purchased, for instance directly from the manufacturer, while also connecting consumers to local service providers and other contractors.

In some cases, the sales and configuration system may facilitate consumer understanding of the consequences of their choices by populating displays on multiple computing devices, such as one computing device displaying a floor plan with which the consumer or the project specialists may drag and drop various options into the project, and a second computing device that displays updated statistics about the project, like cost, with those statistics updated in response to inputs provided on the other computing device. Interacting with a floor-plan based view is expected to be relatively intuitive for users, particularly as compared to systems that merely accumulate a bill of materials without displaying the location of features in the building. (That said, embodiments are not limited to those offering floor plan based views, as other features are independently useful.) Further, some systems may update these budgets based both on the cost of hardware added to the project and other costs associated with that hardware, like cabling, conduit, labor, and the like. As a result, in some use cases, the project specialist and the consumer may iterate through a relatively large number of various designs, with the consumer being relatively well-informed about their choices in the various trade-offs, without scheduling an excessive number of meetings that can cause project planning costs to become excessive.

In some cases, the present system may be used in audio visual planning projects, as these projects often involve a relatively large number of choices, with relatively complicated interactions between technical choices, both for the budget and for the configuration of various subsystems. The present techniques, however, are also suitable for a variety of other types of construction-related products and systems, including but not limited to security systems, appliances, electrical fixtures, plumbing fixtures, door/window systems, window coverings, solar/PV systems, cabinetry, furnishings, and all other products and systems that are built/fabricated offsite and delivered to a construction site for installation.

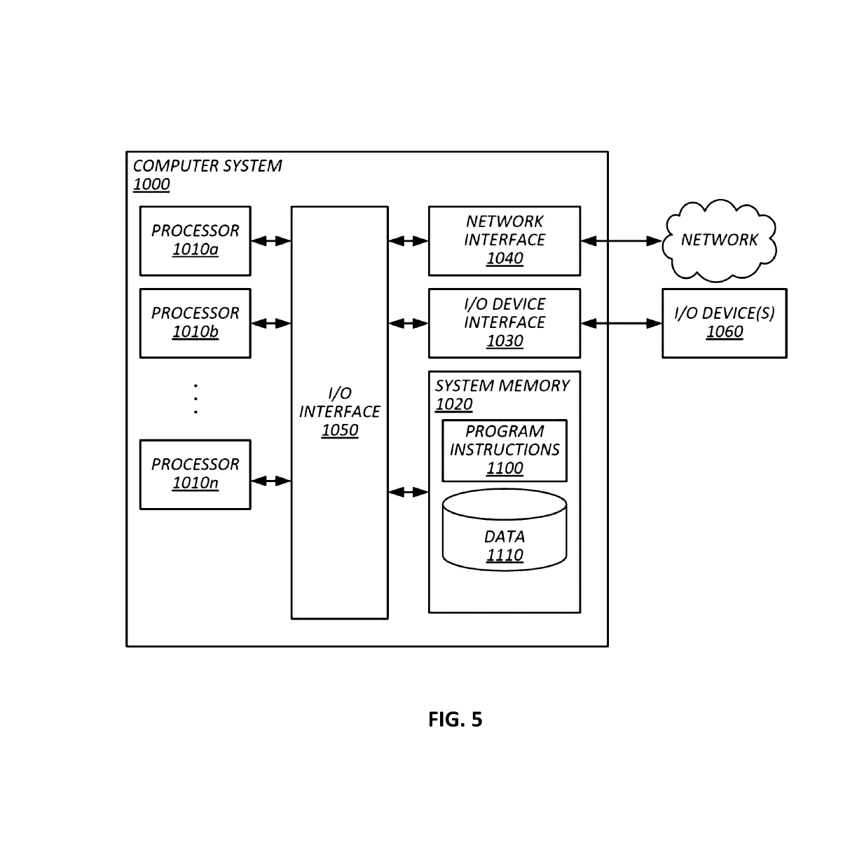

As illustrated by FIG. 1, in some embodiments, the sales and configuration system 10 may include a distributed computing application that communicates over the Internet 18 (and various other networks, such as a cellular network or WiFi™ network in range of a site where a session, as described below, is being conducted with a consumer). In some cases, the project specialists may bring two computing devices, labeled portable computer 12 and tablet computer 16 (both with a wireless network interface and an on-board power supply, like a battery), to a meeting with the consumer, and those computing devices may communicate via the Internet and a wireless network with a hosted sales and configuration system 10. In some cases, the computing devices in FIG. 1 may be implemented with one or more of the computing devices described below with reference to FIG. 5.

In some cases, the portable computer 12 is a laptop computer coupled to a relatively large touchscreen panel, such as a 15-inch or larger (e.g., a 27-inch) touchscreen panel 14. In some embodiments, the portable computer 12 and a touchscreen panel 14 may be integrated into a single computing device. In some embodiments, the touchscreen panel 14 may be a relatively large display selected to facilitate display of a relatively large amounts of information, with relatively high-resolution, for example, when displaying details of a floor plan to a consumer. Often smaller displays, for instance, in handheld tablet computers, are not suitable for conveying the overall project scope to a consumer. That said, some embodiments may use one or more tablet computers in place of the portable computing device illustrated in FIG. 1.

The tablet computer 16, in some embodiments, may be a hand-held tablet computer, for example, a 7, 8, 10 or 12 inch tablet computer (or one having a screen smaller than 15 inches diagonal). Using a second, smaller device, is expected to facilitate ease of transport, and some consumers may wish to hold the tablet computer when collaborating on a design with a project object specialist. As explained below, the tablet computer 16 may display updated project information responsive to changes entered on the touchscreen. In some cases, devices 12 and 16 may execute different operating systems, e.g., Windows and iOS, respectively.

In some cases, the portable computer 12 and the tablet computer 16 may execute a special-purpose native application designed to interface with the sales and configuration system, for instance, via an application-specific programming interface to which the system is responsive. Or in some embodiments, the portable computer in the tablet computer may execute a browser that receives and displays interfaces and sends instructions and inputs from and to the sales and configuration system. In some embodiments each system 12 and 16 may interface with the sales and configuration system 10 via a special-purpose native application, a web browser, or a combination (e.g., one using a native application and the other using a browser). The functionality described herein may be provided by the computer systems described herein executing instructions stored on a tangible, non-transitory, machine-readable medium (which is not limited to a monolithic body of media in a single device, and may include instructions distributed among multiple devices).

In some embodiments, the sales and configuration system is operative to provide a consistent experience across the computing devices and design sessions, such that both the project specialist and the consumer may collaborate on the design together with both of the illustrated computing devices, and the state of that collaboration may remain consistent across multiple such sessions.

In some embodiments, the sales and configuration system 10 includes a server 24, a projects data store 30, a products data store 28, a configuration data store 26, graphical assets 20, and a controller 22. In some embodiments, the server 24 may be a Web server or an application-program interface (API) server that interfaces with the illustrated portable computer 12 and tablet computer 16 via the Internet 18. One set of client devices 12-16 are shown for a single design session with a consumer at a single physical location (e.g., in building where a design will be deployed or at a designer's office), but embodiments are consistent with may more instances of this set of client-side devices 12-16 having ongoing concurrent sessions with the system 10 (e.g., more than 100, and in many commercially relevant use cases, more than 1,000 concurrent sessions distributed over a large geographic area, like North America).

In other embodiments, for instance, to facilitate use in remote areas without Internet access, some embodiments may cache the information relating to a project on the portable computer, and the controller and server may be executed as a separate process on the portable computer, with the user interface directed to that separate process, for instance, by directing a web browser to a loopback IP address of the portable computer. For instance, the portable computer 12 may execute the same code as the system 10, e.g., by storing an image of system 10 while robust network connections are available before visiting a site in the field. In some embodiments, the portable computer 12 may detect that network access is later unavailable, and re-route exchanges from the Internet-accessible version of the system 10 to the loopback address and the locally executed image of the system 10. In some embodiments, the portable computer 12 may later determine that network access has been restored, and data structures updated in the system 12 may be synchronized with those the system 10 to reflect updates made in the field. That said, not all embodiments provide these benefits, as there are various independently useful inventions described, and not all of these inventions address all problems noted.

Further, in some cases, even with network connections, latency, limited bandwidth, and large graphical assets may cause the user experienced to deteriorate due to lag and lack of responsiveness with traditional computer systems. Accordingly, some embodiments may cache some, or in some cases, all of graphical assets 20 on the portable computer 12 (e.g., before leaving an area with robust network access) for a field deployment. These locally cached assets may be displayed in the user interfaces described below relatively quickly and responsively by drawing upon locally cached copies. For instance, floor plan images often consume relatively large amounts of data and these may be cached locally. Or some embodiments may use other techniques to compress data to improve responsiveness. For instance, some embodiments may compress or obtain floor plans into a vector graphics format rather than a bitmap format to facilitate responsive network exchanges and detailed, high-quality image presentation even at high zoom levels. That said, not all embodiments provide these benefits, as there are various independently useful inventions described, and not all of these inventions address all problems noted.

In some embodiments, the projects data store 30 may include a plurality of projects records, each project record corresponding to a single undertaking between a consumer and the entity operating sales and configuration software, for instance, a project to install audiovisual equipment in a home or commercial building, a project to renovate a home or building, a project to landscape a property, or the like. In some embodiments, each project may include parameters of the project, like a square footage of the building, an address of the building, status records of the project, a plurality of revision records of the project, uniform resource identifiers of one or more floor plans for a building, records indicating inputs to add things to the project or remove things from the project, a record indicating whether a consumer has signed off on the project, and one or more URLs by which the consumer may view information about the project, for instance, on their home computer. In some cases, each project record may further be associated with a unique identifier and identifiers of user accounts authorized to view the project or modify the project, depending upon the level of access granted.

Each project revision record may include a revision number or date, by which the projects may be sequenced, a value indicating which revision is designated as the current revision indicating the parties current preferences, and information by which an instance of a revision of the project is defined, such as hardware added to the project and locations of the hardware on the floor plan. In some cases, changes may be undone by reverting to an earlier revision.

Added hardware, in some embodiments, may be identified in the products data store 28, which may include a plurality of product definitions, each product definition including a unique identifier, a description of a corresponding product that may be added to a project, a specifications of the product, uniform resource identifiers of images of the product, and costs and other hardware associated with the product. Examples of associated costs include the cost of installation, the cost of wiring, pointers to other products that are bundled with the product, and the like.

The configuration data store 26 may include a plurality of rules specifying valid configurations of various systems that may be installed in a project. Such systems may include collections of products that interface with one another, for example, an audio system or a visual system or in irrigation system, or the like. By way of example, such rules may indicate that speakers wattage should be greater than receiver output wattage to avoid damaging the speakers, or that a TV requires a certain data capacity of a receiver.

Some embodiments may further include a collection of graphical assets 20, such as images of products and images of floor plans. In some cases, these graphical assets may be identified by uniform resource identifiers in corresponding product and project records. In some embodiments, graphical assets relating to floor plans may be obtained, for example, from architects in advance of a meeting with the consumer, and graphical assets relating to products may be obtained from product manufacturers.

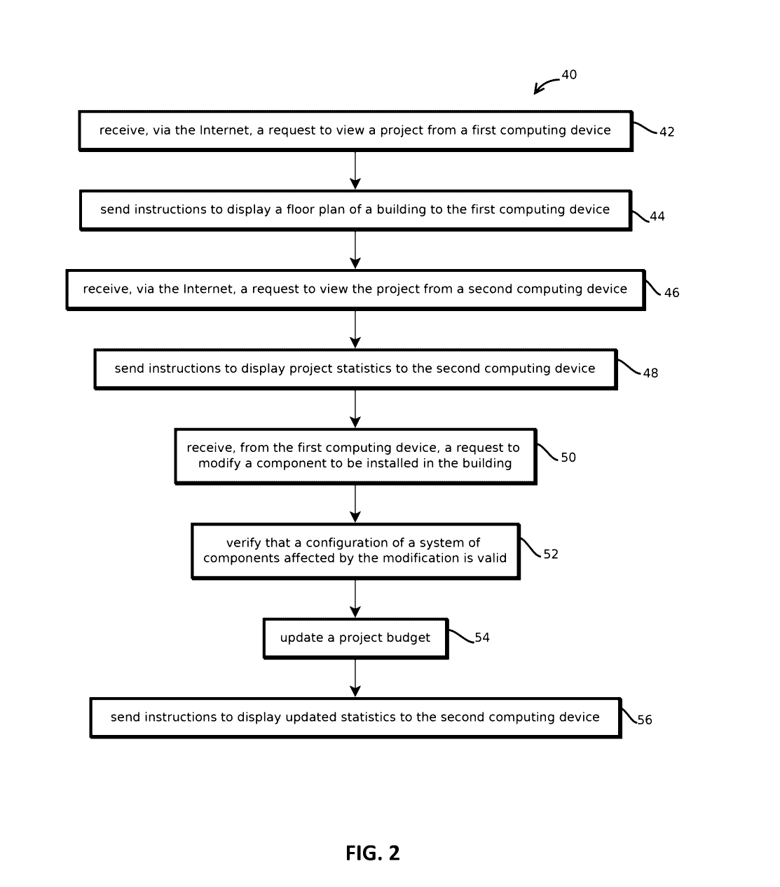

The controller 22 may interface with each of the above-described components and manage sessions with the portable computer and the tablet computer. In some cases, the controller 22 may manage a plurality of concurrent sessions, for example, during a plurality of concurrent meetings with different consumers relating to different projects. In some embodiments, the controller 22 may execute a process 40 described below with reference to FIG. 2.

In some embodiments, the process 40 may include receiving, via the Internet, a request to view a project from a first computing device 42. In some cases, this request may include receiving login credentials and an identifier of a project. Receiving the request may include receiving a plurality of inputs over a plurality of exchanges with the remote computing device.

Next, some embodiments may send instructions to display a floor plan of the building to the first computing device 44. In some cases, this may include instructions to send a display of a floor plan to the portable computing device coupled to the touchscreen display in FIG. 1.

Next, some embodiments may receive, via the Internet, a request to view the project from a second computing device 46. In some cases, this request may be a request from the tablet computer illustrated in FIG. 1. In some cases, the request may include user agent information indicating the types of computing devices, and the controller may select the appropriate display based on the user agent information, for instance, directing the floor plan to the portable computer and budget statistics to the tablet computer. Or in some embodiments, a user may select which role each device will play.

Next, some embodiments may send instructions to display project statistics to the second computing device 48. A variety of different types of project statistics may be displayed. For instance, some embodiments may display an updated budget reflecting the current project additions or subtractions entered on the first computing device. For instance, a user may drag-and-drop a new television onto a location in the floor plan on the first computing device, and in response: this information may be sent to the sales and configuration system; the sales and configuration system may calculate an updated budget reflecting both the cost of the hardware and the cost of installation and associated hardware; and this cost information may be used to calculate an updated budget that is sent to the second computing device for display. The second computing device may maintain a websocket connection by which this information is pushed to the second computing device, or the second computing device may periodically poll the system for updates (e.g., once a second).

Project statistics may include a variety of statistics, examples of which are described below with reference to slides of an included presentation. In some cases, project statistics may include a histogram illustrating the current project in the context of a population of projects. For instance, an amount spent on each of a population of projects, for instance, more than 10 or more than 100, may be grouped into bins of a histogram, and those bins may be displayed in a bar chart with heights indicating the number of projects falling within those bins, along with an identifier of the bin into which the current project falls. As a result, consumers may draw some comfort or otherwise adjust to more closely align with more mainstream choices. Or some consumers may appreciate knowing that their project is an outlier relative to typical projects. In some cases, the histograms or other statistics may be calculated by subsystem or category of the project, for instance, a histogram specific to audio equipment and another histogram specific to video equipment, thereby allowing consumers to see how well balanced their spending is relative to others. To this end, in some cases, products in the product data store may be organized in a hierarchical taxonomy by which the products are placed, or clustered, into these groups or subsystems, e.g., electronics→audio_equipment→speakers, or electronics→video_equipment→OLED_displays.

In some embodiments, a histogram may be approximated or simulated with a Gaussian bell curve, e.g., by calculating a standard deviation and mean of budgets in a population of past projects, and applying these values to a Gaussian function. In other embodiments, other distributions may be used or selected among, e.g., audio equipment budgets may tend to follow a power law distribution, while video equipment budgets may tend to follow a Poisson distribution

In some cases, the second computing device may also display product specifications relating to the television, an image of the television, and an inventory of costs associated with adding the television, thereby helping the consumer make relatively informed, real-time choices during a single design session.

As noted, the statistics displayed on one device may be updated responsive to user inputs on the other device. To this end and others, some embodiments may include receiving, from first computing device, a request to modify a component to be installed in the building (which may include a request to modify a component outside the building but on the same job site, e.g., adjusting landscaping or a security camera) 50. Modification, in this sense, refers to modifying the draft design. In some cases, this request may be a request to add hardware, modify hardware, or remove hardware that was previously selected. Then, some embodiments, may verify that a configuration of a system of components affected by the modification is valid 52. In some cases, verification may include accessing the above-described rules in the configuration data store, and comparing those rules to the requested, modified configuration to ascertain the validity, e.g., with a rules engine. An indication of an invalid configuration may be sent to one or more of the computing devices, and the modification may be prohibited, in some embodiments responsive to an invalid configuration. In some embodiments, this process may further include updating a project budget or other statistics 54 and sending instructions to display the updated statistics to the second computing device 56.

Thus, consumers may see a real time (e.g. within the range of a few seconds) trade-off in budget and configuration constraints responsive to the choices that they make during a meeting with a product specialist. This is expected to facilitate faster project definitions that more closely align with the consumer's true references. Further, some embodiments may provide an interface, e.g., on the touchscreen, by which a consumer may enter a signature, committing to the design to further expedite the project. In some cases, the consumer may be provided printed material and a URL with a summary of the project, terms of a contract, a budget for the contract, and the like.

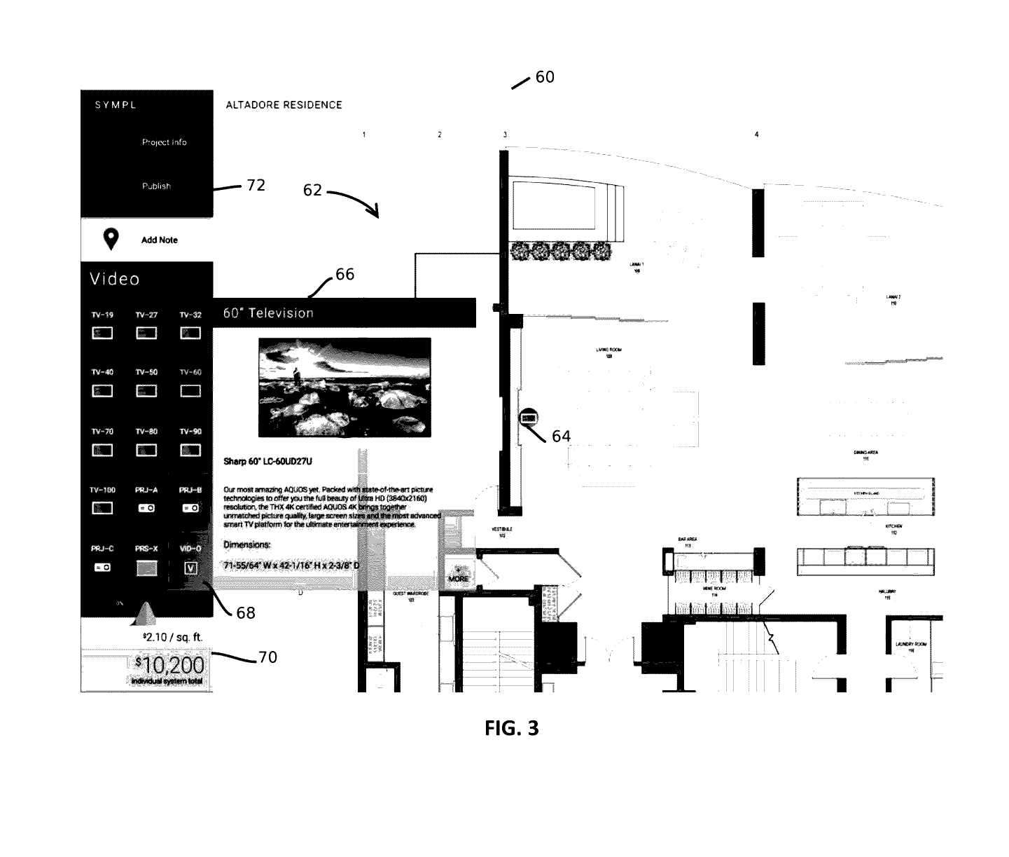

FIG. 3 shows an example of a graphic user interface 60, e.g., displayed by the portable computer 12 on the touchscreen panel 14 of FIG. 1. The interface may include a floor plan image 62 (e.g., a plan view showing the relative position of walls, fixtures, and furniture). Or some embodiments may display other views, like an elevation view, or a perspective view. Some embodiments may obtain a three-dimensional model of the space, e.g., with a three-dimensional depth sensor (e.g., with an integrated and fused time-of-flight sensor or Lidar sensor and image sensor) executed by the tablet device, and display a graphical user interface overlaid upon a resulting three-dimensional model. In some cases, three-dimensional models of items added to the design may be superimposed on the model. Or some embodiments may instead display in image sensed by a rear-facing camera of the tablet, and overlay on the image three-dimensional models of selected designs with an augmented reality display, using the described three-dimensional space sensors to determine positions of the items in the view.

The user interface may include a plurality of icons, like icon 64, representing a selected item added to the design. The icon 64 may be positioned on the floor plan (or other view) in the position where the corresponding item will be added to the building. In some embodiments, the icon is associated with plurality of event handlers that listen for various user inputs (e.g., touching, releasing, dragging, and double touching, etc. associated with the pixels occupied by the icon). In some cases, the icon is user selectable to move the icon, and corresponding item in the design, to a different part of the floor plan. Corresponding records in the project play may be updated in response, and in some cases, a clustered cost and configuration may be updated (e.g., to confirm that wire-run-length limits are not exceeded, and to reflect added or reduced installation costs of a new location). In some cases, the icon 64 is user-selectable with a different interaction (e.g., double tapping) to reveal a more detailed description 66 of the corresponding item. Some embodiments may further respond by displaying an array of substitute items 68 in the same category to facilitate fast navigation among options. In some embodiments, the user interface 60 includes a budget estimate 70 and a publish interface 72 that, when selected, causes the above-described signable project specification to be saved and, in some cases, finalized and sent for signatures.

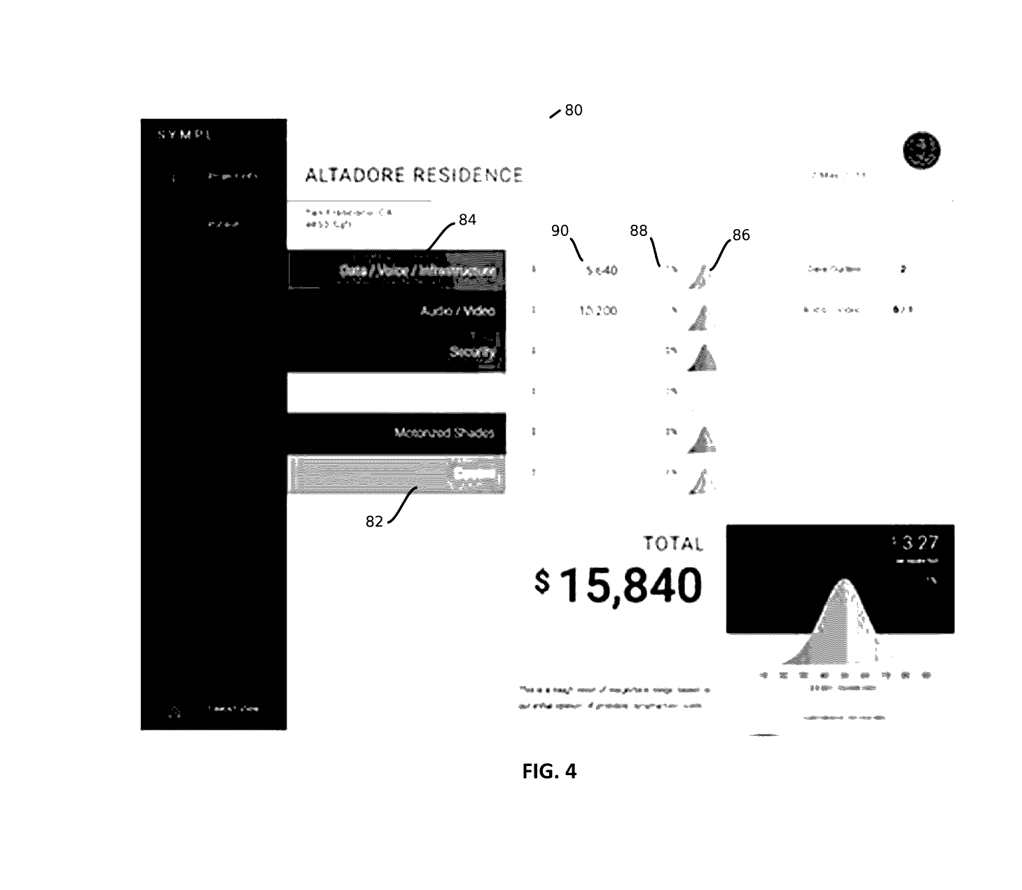

FIG. 4 shows another example of a graphical user interface 80 that may be displayed concurrently on the table computer 16 of FIG. 1, while interface 60 is shown on touchscreen 14. Some embodiments may cause the two interfaces 60 and 80 to update responsive to changes in the other, e.g., via messages sent through the sales and configuration system 10 and a local wireless network or the Internet. As shown, some embodiments include a plurality of categories of expenditures 82 and 84 (in this case six, but some may include seven or more) within the design presently being considered on with the user interface 60. Each category may have an amount, a percentage within a distribution of other projects 88, and a graphic of a distribution showing where the current design falls within the distribution 86. In some embodiments, the amounts reflect total project costs 90 in the categories, e.g., for a TV, the cost of the TV, wiring, installation, and taxes. These values and visualizations may update responsive to changes made on the other computing device, thereby providing an easily visually parsed representation of the effects of various changes as design options are considered.

Additional details of a specific embodiment of the above-described techniques are described in images of a presentation showing that embodiment in the provisional patent application incorporated by reference. It should be understood that the presentation relates to an embodiment and does not purport to define the scope of the invention, which does not imply that anything else described herein other than the claims as ultimately issued in the patent serve to define the scope of the invention.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, any such conflicting text in such incorporated by reference U.S. patents, U.S. patent applications, and other materials is specifically not incorporated by reference in this patent.

The present techniques will be better understood with reference to the following enumerated embodiments:
1. A method, comprising: receiving, via the Internet, a request to view an project from a first computing device; sending instructions to display a floor plan of a building to the first computing device; receiving, via the Internet, a request to view the project from a second computing device; sending instructions to display project statistics to the second computing device; receiving, from the first computing device, a request to modify a component to be installed in the building; and in response to the request to modify: updating project statistics; and sending instructions to display updated statistics to the second computing device.
2. The method of embodiment 1, wherein the statistics comprise: a budget for the project that is dynamically updated on a display on the second computing device in response to changes in the project entered on a touchscreen of the first computing device.
3. The method of any of embodiments 1-2, wherein the statistics comprise: data indicating the amount to be spent on the project relative to amounts spent in a larger population of projects.
4. The method of embodiment 3, wherein the data indicating the amount spent comprises: amounts in bins in a plurality of histograms, each histogram corresponding to a different system of components in the project.
5. The method of any of embodiments 1-4, comprising: verifying that a configuration of a system of components affected by the modification is valid.
6. A tangible, non-transitory, machine-readable medium storing instructions that when executed by a data processing apparatus cause the data processing apparatus to perform operations comprising: the steps of any of embodiments 1-5.
7. A system, comprising: one or more processors; and memory storing instructions that when executed by the processors cause the processors to effectuate operations comprising: the steps of any of embodiments 1-5.

What is claimed is:

1. A method, comprising:
receiving, via a network interface, a request to view a project from a first computing device;
sending instructions to display a floor plan of a building to the first computing device;
receiving, via the network interface, a request to view the project from a second computing device;
sending instructions to display project statistics to the second computing device;
receiving, from the first computing device, a request to modify a component to be installed in the building; and
in response to the request to modify:
updating a project statistic; and
sending instructions to display the updated statistic to the second computing device.

2. The method of claim 1, wherein:
the first computing device comprises a laptop computer and touchscreen communicatively coupled to the laptop, the touchscreen being larger than 15 inches diagonally;
receiving, via a network interface, comprises receiving via the Internet and a wireless network;
the project includes an audio-visual design project for a building in which the first computing device and the second computing device are disposed connected to the same wireless network;
sending instructions to display the floor plan comprises sending instructions to display an image cached in memory of the first computing device, where the image is stored in cache memory before receiving the request to view the project;
the second computing device comprises a tablet computing device having a screen smaller than 15 inches diagonally and executing a different operating system from an operating system executing on the first computing device;
sending instructions to display the project statistics comprises:
obtaining, for a first category of audio-visual equipment, a first distribution of expenditures within the first category among a population of audio-visual design projects that is larger than 5;
obtaining, for a second category of audio-visual equipment, a second distribution of expenditures within the second category among the population of audio-visual design projects;
determining a first project statistic indicative of a relative value of expenditures within the first category for the project;
determining a second project statistic indicative of a relative value of expenditures within the second category for the project;
sending, in a serialized data format, data by which a first image of a histogram depicting the first distribution of expenditures and a relative value of the first project statistic compared to the first distribution of expenditures is generated by the second computing device;
sending, in the serialized data format, data by which a second image of a histogram depicting the first distribution of expenditures and a relative value of the first project statistic compared to the first distribution of expenditures is generated by the second computing device, wherein the first and second images are not sent via the Internet and are formed client-side;
the first image and the second image being displayed concurrently by the second computing device while the first computing device concurrently displays an image of the floor plan;
receiving the request to modify the component comprises:
receiving a request from the first computing device to replace a first item of audio-visual equipment in a group of audio-visual equipment and services with a second item of audio-visual equipment,
wherein the group of audio-visual equipment and services includes services to install items in the group, cabling to connect items in the group, and audio-visual equipment,
wherein the audio-visual equipment in the group have been determined to satisfy configuration criteria specific to at least some of items in the group, and
wherein the group is within the first category of audio-visual equipment;
the method further comprises determining that the second item of audio-visual equipment satisfies the configuration specific criteria;
updating project statistics comprises determining an updated first project statistic;
sending instructions to display the updated statistic comprises sending instructions that cause a different image depicting relative value of the updated first project statistic compared to the first distribution of expenditures to be generated by the second computing device; and
at least some items in the project include a display screen to be installed in the building and speakers to be separately installed in the building.

3. The method of claim 1, wherein the statistics comprise:
a budget for the project that is dynamically updated on a display on the second computing device in response to changes in the project entered on a touchscreen of the first computing device.

4. The method of claim 1, wherein the statistics comprise:
data indicating the amount to be spent on the project relative to amounts spent in a larger population of projects.

5. The method of claim 3, wherein the data indicating the amount spent comprises:
amounts in bins in a plurality of histograms, each histogram corresponding to a different system of components in the project.

6. The method of claim 1, comprising:
verifying that a configuration of a system of components affected by the modification is valid.

7. The method of claim 1, comprising:
executing a server on the first computing device, wherein receiving the request comprises receiving the request via a loop-back Internet Protocol address;
creating an updated record of the project in memory of the first computing device;
determining that network access is available to the first computing device; and
synchronizing the updated record of the project with another, older version of the project stored in a sales and configuration system.

8. The method of claim 1, wherein a user interface of the first computing device concurrently displays:
the floorplan;
icons representing items to be installed as part of the project overlaid on the floorplan proximate to wherein in the building the items are to be installed.

9. The method of claim 8, wherein the user interface of the first computing device is configured to also concurrently display a description of a given item responsive to a user selecting an icon representing the given item.

10. The method of claim 9, comprising:
receiving approval of the project; and
in response, generating an electronically signable specification of the project; and
sending the electronically signable specification of the project to a user device.

11. The method of claim 1, comprising:
executing the project.

12. A tangible, non-transitory, machine-readable medium storing instructions that when executed by a plurality of computing devices effectuate operations comprising:
receiving, via a network interface, a request to view a project from a first computing device;
sending instructions to display a floor plan of a building to the first computing device;
receiving, via the network interface, a request to view the project from a second computing device;
sending instructions to display project statistics to the second computing device;
receiving, from the first computing device, a request to modify a component to be installed in the building; and
in response to the request to modify:
updating a project statistic; and
sending instructions to display the updated statistic to the second computing device.

13. The medium of claim 12, wherein the statistics comprise:
a budget for the project that is dynamically updated on a display on the second computing device in response to changes in the project entered on a touchscreen of the first computing device.

14. The medium of claim 12, wherein the statistics comprise:
data indicating the amount to be spent on the project relative to amounts spent in a larger population of projects.

15. The medium of claim 14, wherein the data indicating the amount spent comprises:
amounts in bins in a plurality of histograms, each histogram corresponding to a different system of components in the project.

16. The medium of claim 12, the operations comprising:
verifying that a configuration of a system of components affected by the modification is valid.

17. The medium of claim 12, the operations comprising:
executing a server on the first computing device, wherein receiving the request comprises receiving the request via a loop-back Internet Protocol address;
creating an updated record of the project in memory of the first computing device;
determining that network access is available to the first computing device; and
synchronizing the updated record of the project with another, older version of the project stored in a sales and configuration system.

18. The medium of claim 12, wherein a user interface of the first computing device concurrently displays:
the floorplan;
icons representing items to be installed as part of the project overlaid on the floorplan proximate to wherein in the building the items are to be installed.

19. The medium of claim 18, wherein the user interface of the first computing device is configured to also concurrently display a description of a given item responsive to a user selecting an icon representing the given item.

20. The medium of claim 19, the operations comprising:
receiving approval of the project; and
in response, generating an electronically signable specification of the project;
sending the electronically signable specification of the project to a user device; and
steps for forming a display with a plurality of distributions of expenditures.
